(19) United States
(12) Patent Application Publication
(10) Pub. No.: US 2004/0234102 A1
(43) Pub. Date: Nov. 25, 2004

(54) Method for detecting accident

(76) Inventor: Bong Keun Lee, Gyeonggi-do (KR)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 10/689,497

(22) Filed: Oct. 20, 2003

(30) Foreign Application Priority Data
Dec. 13, 2002 (KR) 79442/2002

(51) Int. Cl. G06K 9/00

(52) U.S. Cl. 382/104; 348/137

(57) ABSTRACT

Disclosed is a method for detecting an accident more swiftly and reliably. The method for detecting an accident obtains an image from a predetermined region on a road, determining whether there exists an accident or not depending on change transition of gray levels for pixels on a line type trap set in advance on the basis of the obtained image. At the moment, a real vehicle and a shadow could be discriminated with use of quantity of change and frequency of the gray levels on the line type trap.

### BACKGROUND OF THE INVENTION

1. Field of the Invention

The present invention relates to a method for detecting a car accident on a road and more particularly to a method for detecting a car accident on a road in a swifter and more reliable manner.

2. Background of the Related Art

Dictionary definition of an “accident” is an unfortunate event or circumstance. Similarly, a car accident means an unfortunate event or happening on a road causing loss or injury. Car accidents are resulted not only from careless driving but also from unexpected vehicle troubles such as a dead battery, and fallen objects. Either way, car accidents reduce capacity of the road surface, and maintenance work needs to be done on the road.

In case such accident occurs in a road, it is required to quickly inform a traffic control center of the accident. Up to now, car accidents have usually been reported by drivers of passing-by vehicles who happened to witness the accidents.

Even after a car accident report is made, it takes time to control and pull over a vehicle (or vehicles) involved in the accident out of the spot. Therefore, a lot of vehicles behind cannot help but waiting until a car accident scene is cleared or are forced to take detour on other roads.

Particularly, in a country like Korea where distribution and shipment are very expensive and heavily dependent on terrestrial transportation, occurrence of such accident has emerged as a serious problem.

Under these circumstances, a method for detecting a car accident, capable of checking the presence of an accident vehicle on the road, has been suggested recently.

FIG. 1 is an exemplary view illustrating a method for detecting a car accident of a related art.

Namely, FIG. 1 shows a screen displaying an image obtained through a video camera installed in the inside of a tunnel. This method for detecting an accident has been suggested in Australia.

Referring to FIG. 1, there are three lanes 3 and sidewalks 1 on a road according to the screen. Also, a plurality of box type traps 7 is disposed at the lanes 3 and the sidewalks 1, respectively. Each of the box type traps 7 includes a plurality of pixels. Also, depending on circumstances, the number of pixels included in one box type trap can be changed.

When a vehicle 5 drives along the lane 3, the movement of the vehicle 5 is detected by means of the box type trap 7 set on the screen.

Namely, each pixel included in the inside of the box type trap 7 on the lane 3 is given a gray level according as a video camera (not shown) takes an applicable roadway.

Detecting gray level changes of each box type trap 7, one can find out whether the vehicle 5 is driving or stopped.

The video camera takes pictures of the road in real time mode, and those filmed pictures are sent to the traffic control center in real time mode.

Therefore, if the gray level of each box type trap 7 is traced in time series, any car accident can be detected.

Here, if the gray level changes in time series, it means that the vehicle 5 is moving (driving) at the moment, while if the gray level does not change in time series, it means that the vehicle 5 is stopped.

Once a car accident is detected by the foregoing procedure, a predetermined alarming signal is emanated, and proper steps are taken.

But, as the method for detecting car accidents of the related art uses gray levels for numerous pixels in order to detect a single accident, a number of computing processes as well as a great amount of time are required to detect the accident.

Also, the above method works more effectively only in a place where there is no change in the neighboring environment such as the inside of the tunnel.

However, on most roadways, unlike tunnels, neighboring environment always changes, and thus the related method is not effective for identifying vehicles and/or vehicles involved in accidents.

In other words, besides shadows of vehicles, there are many other shadows of non-vehicles such as street trees or streetlights on the road. As vehicles cast shadows on the road, the related art method often mistakenly regard the shadows as moving vehicles.

As such, the related art method is not effective for the recognition of a real moving vehicle, and this in turn may cause a serious problem in reliability thereof.

### SUMMARY OF THE INVENTION

An object of the invention is to solve at least the above problems and/or disadvantages and to provide at least the advantages described hereinafter.

Accordingly, one object of the present invention is to solve the foregoing problems by providing a method for detecting an accident in a swifter and more reliable manner, using a line type trap.

Another object of the present invention is to provide a method for detecting an accident, capable of improving reliability by preventing inaccurate identification of a vehicle using gray level information.

The foregoing and other objects and advantages are realized by providing a method for detecting an accident including the steps of: obtaining an image from a predetermined region on a road; computing gray levels for each pixel corresponding to a predetermined line type trap from the obtained image; and determining whether there exists an accident or not depending on change transition of the computed gray level for a predetermined period of time.

According to another aspect of the invention, a method for detecting an accident includes the steps of: obtaining an image from a predetermined region on a road; computing gray levels for each pixel corresponding to a predetermined line type trap from the obtained image; tracking a vehicle using quantity of change for the computed gray levels; and determining whether there exists an accident or not by tacking the gray levels for the tracked vehicle for a predetermined period of time.

### BRIEF DESCRIPTION OF THE DRAWINGS

The above objects, features and advantages of the present invention will become more apparent from the following detailed description when taken in conjunction with the accompanying drawings, in which

FIG. 1 is an exemplary view of a screen explaining a method for detecting an accident of a related art.

FIG. 2 is an exemplary view of a screen explaining a method for detecting an accident according to a preferred embodiment of the present invention.

FIG. 3A and FIG. 3B are graphs showing frequency for a vehicle and a non-vehicle according to a preferred embodiment of the present invention.

FIG. 4 is a flowchart explaining a method for detecting an accident according to a preferred embodiment of the present invention.

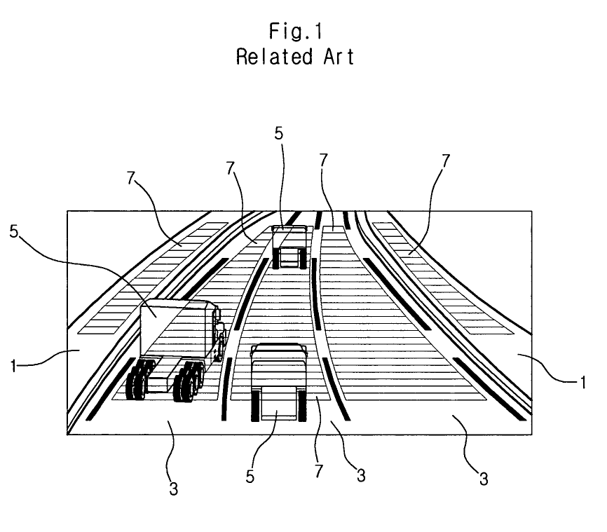

### DETAILED DESCRIPTION OF THE PREFERRED EMBODIMENTS

The following detailed description will present a method for detecting an accident according to a preferred embodiment of the invention in reference to the accompanying drawings.

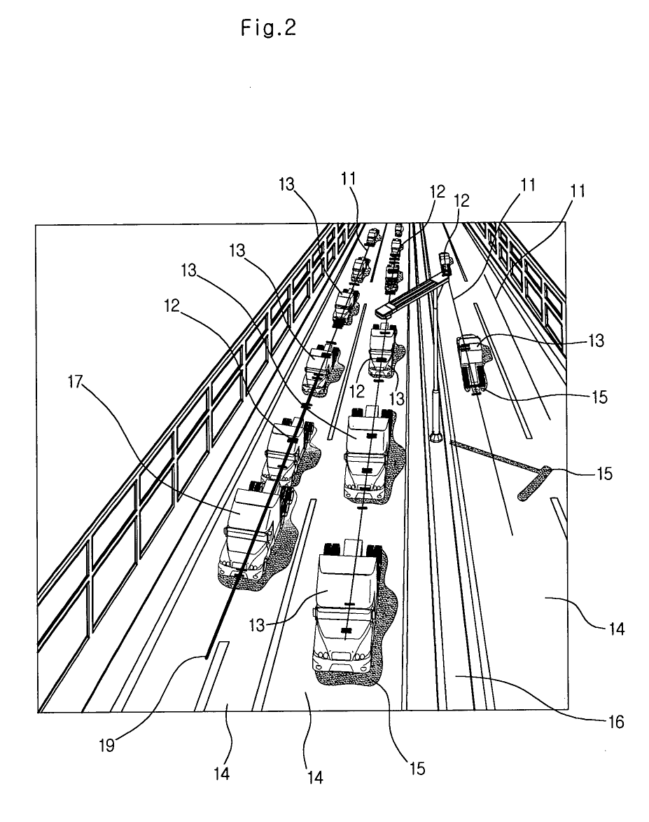

FIG. 2 is an exemplary view of a screen explaining a method for detecting an accident according to a preferred embodiment of the present invention.

FIG. 2 shows a screen displaying an image obtained through a video camera installed in a road.

In this screen, there exists lanes 14 on both sides with the center divider 16 centered and there exist sidewalks or buildings in the outside of the lanes 14. At the moment, vehicles 13 move on the lanes 14, respectively.

Also, there exist vehicles 13 in moving and shadows 15 by sunlight on each lane 14.

A predetermined trap 11 of a line type is formed on a screen of an image obtained through the foregoing procedure.

The line type trap 11 is set on each lane 14 along a progressing direction of a vehicle 13. Of course, the line type trap 11 may merely be set on the lane 14 regardless of the position of the lane 14 as far as the trap 11 is positioned on the lane 14. At the moment, the line type trap 11 is set in a row in parallel with the lane 14.

The present invention detects an accident using gray levels of relevant pixels on the line type trap 11 set in this manner. At the moment, each pixel should be laid over the line type trap 11. Namely, gray levels for other pixels not laid over the line type trap 11 is excluded.

As described already, according to the related art, the box type trap is set, in which a plurality of pixels are included and gray levels for such pixels are used for detecting an accident, whereby a good many computations have been required.

The present invention, however, detects an accident by considering only pixels included on the line type trap 11, thereby detecting an accident in a swifter manner.

Though the gray levels for pixels arranged in a row on such line type trap 11 are generally accurate, the gray levels for other pixels may not be accurate due to some other factors.

In order to resolve such problem, the present invention computes an average value of gray levels for one pixel and a predetermined number of pixels existing in back and forth of the one pixel, designating the gray level for the computed pixel as a representative gray level for the relevant pixel. In this manner, representative gray levels are computed for all the pixels arranged on the line type trap 11.

For example, presume that pixel 1, pixel 2, pixel 3, pixel 4, pixel 5, pixel 6, pixel 7 are included on the line type trap 11 and there exist gray levels for each pixel. Regarding the pixel 1, an average value for each gray level of the pixel 1 and the pixel 2 is computed and the computed gray level could be designated as the gray level for the pixel 1.

Also, an average value for each gray level of the pixel 1, the pixel 2, the pixel 3 is computed, whereby a representative gray level for the pixel 2 is computed. Through such procedure, a representative gray level is computed from the pixel 1 to the pixel 7.

Through analysis of change transition of each representative gray level computed in this manner, the relevant vehicle 13 is recognized and whether there occurs an accident for the recognized vehicle or not, could be determined.

In FIG. 2, a vehicle No. 3 is determined to have caused an accident and a more dark line type trap 19 is marked in back and forth of such vehicle 17 determined to have caused an accident.

The representative levels for each pixel are computed in this manner, whereby accuracy for the gray level could be improved even more.

Also, if a vehicle 13 in moving is recognized through the line type trap 11 on the screen, a mark 12 corresponding to the relevant vehicle 13 is marked perpendicularly with respect to the line type trap 11.

In the meantime, there exists a shadow 15 due to a vehicle 13 or a shadow 15 due to a street tree and a streetlight on the screen.

If there exists such shadow 15 on the lane, the shadow may be mistaken as a vehicle.

In order to prevent such malfunction, the present invention has, in advance, gray level information for each vehicle and shadow.

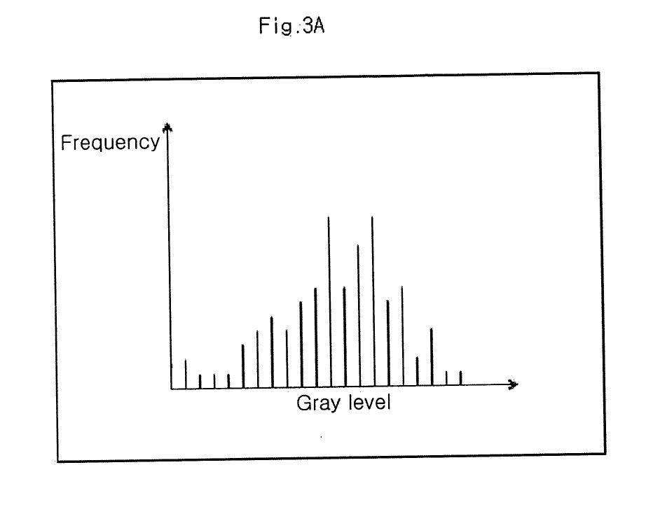

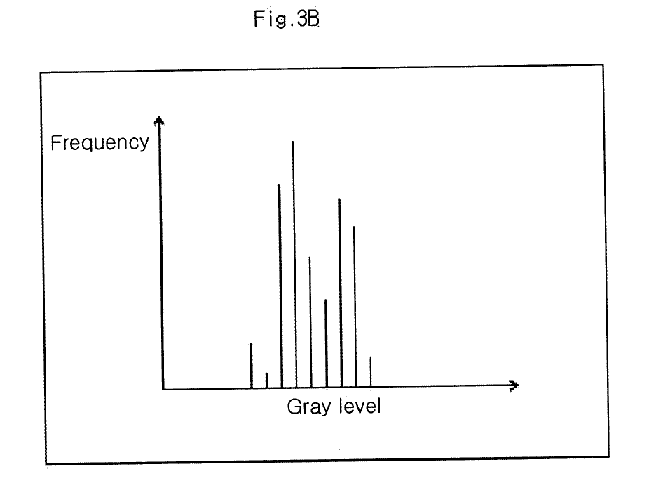

Such gray level information is shown in FIG. 3A and FIG. 3B.

Here, FIG. 3A shows gray level information for a vehicle. Generally, a vehicle has a variety of brightness reflected by many parts existing in a vehicle itself, so that a variety of gray levels exist. Namely, a wide range of gray levels exists ranging from a very high level to a very low level. Accordingly, frequency of each gray level is relatively low.

FIG. 3B shows gray level information for a shadow. Generally, a shadow represents similar gray levels for all the region on the whole. Accordingly, the gray levels are not various compared to a vehicle, but the frequency rather is high.

Therefore, in case of a vehicle, quantity of change of the gray level is wide but the frequency is relatively low. Also, in case of a shadow, quantity of change of the gray level is narrow but the frequency is relatively high.

If such gray level information is known in advance, whether the relevant gray level is a real vehicle or a shadow, could be discriminated by comparison of the gray level information for the region presently recognized as a vehicle with a predetermined gray level information.

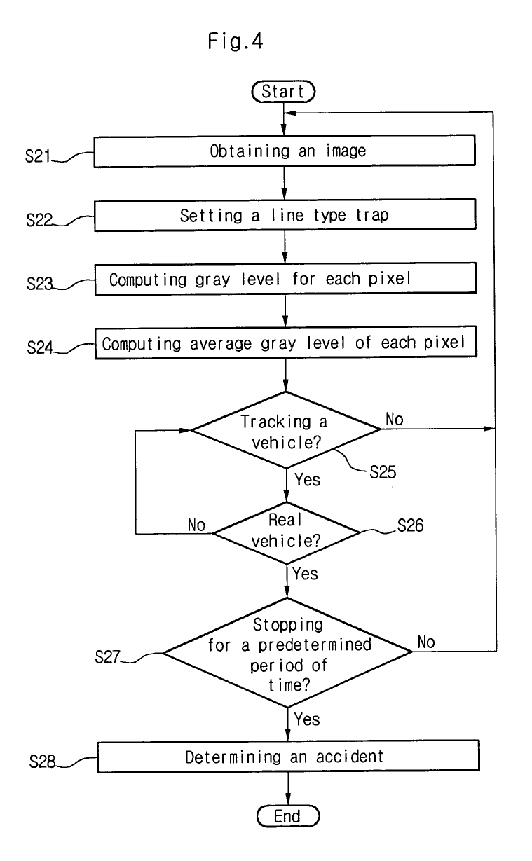

FIG. 4 is a flowchart explaining a method for detecting an accident according to a preferred embodiment of the present invention.

Referring to FIG. 4, on the first place, an image is obtained from a predetermined region on a road using a video camera (S 21). Such video camera is installed in an intersection of a downtown or an express highway.

If an image is obtained in this manner, a line type trap is set on the basis of the obtained image (S 22). At the moment, in case that the video camera obtains an image from the same predetermined region regularly, the line type trap may also be set in advance.

Such line type trap is preferably set on the lane in parallel with the lane.

Also, the obtained image could be displayed through a predetermined screen. An operator could also visually detect whether a vehicle has caused an accident through an image displayed in this manner.

Of course, the purpose of the present invention is to detect an accident of a vehicle using change transition of the gray level for the obtained image, not to visually detect an accident of a vehicle in this manner.

In the meantime, if the line type trap is set, the gray levels for each pixel corresponding to the set line type trap are computed (S 23). Here, computing means obtaining the gray levels for the pixel that fall on the line type trap among the gray levels obtained upon picture taking by the video camera.

If the gray levels for each pixel are computed in this manner, the representative gray levels for each pixel are computed for each predetermined region in order to secure accuracy for the gray level of each pixel (S 24).

As described above, an average value of the gray levels for one pixel and a predetermined number of pixels existing in back and forth of the one pixel is computed, and the computed average value is designated as the representative gray level for the one pixel.

Regarding the next pixel, an average value of the gray levels for the next pixel and a predetermined number of pixels existing in back and forth of the next pixel, is computed in a similar manner and the computed average value is designated as the representative gray level for the next pixel. Through such procedure, the representative gray levels for all the pixels included on the line type trap, are computed.

With use of quantity of change for the average gray levels computed in this manner, a vehicle is tracked (S 25). Namely, analysis of the gray levels for each pixel existing on the line type trap, reveals that the gray levels are different between a point where a vehicle exists and a point where a vehicle does not exist. If a point where the gray levels change exists in this manner, it is recognized that a vehicle exists on the relevant point.

If a vehicle is traced in this manner, comparison of the gray level information for the tracked vehicle with gray level information set in advance, is performed, whereby whether it is a real vehicle or not, is determined (S 26).

Here, gray level information represents quantity of change and frequency for the gray level.

As described above, a vehicle and a shadow which is not the vehicle, are different in their gray level information (refer to FIG. 3A and FIG. 3B).

With use of such different gray level information, whether a vehicle presently tracked is a real vehicle or not, could be determined.

Namely, as a result of comparison of gray level information for the tracked vehicle with gray level information set in advance, if gray level information for the tracked vehicle is in agreement with gray level information for a vehicle set in advance, the tracked vehicle is determined to be a real vehicle.

On the contrary, if the gray level information for the tracked vehicle is in agreement with gray level information for a shadow set in advance, the tracked vehicle is determined to be a shadow.

If a vehicle is determined to be a real vehicle by the step of S 26, whether the tracked vehicle stops for a predetermined period of time, is judged (S 27). Such judgment could be easily performed by checking whether the gray level for the tracked vehicle does not change for a predetermined period of time.

Namely, in case that the gray level for the tracked vehicle does not change for a predetermined period of time, the tracked vehicle is considered to remain stopped and there is high possibility of an accident of the relevant vehicle.

On the contrary, in case that the gray level for the tracked vehicle constantly changes for a predetermined period of time, the tracked vehicle is considered to be moving and a vehicle may be a normal vehicle.

Judging whether a vehicle stops for a predetermined period of time in this manner, is for preventing, in advance, a fallacy of mistaking a normal vehicle temporarily stopping as a vehicle causing an accident in case that a vehicle temporarily stops due to a stand-by traffic signal.

Therefore, in case that the tracked vehicle is considered to remain stopped for a predetermined period of time as a result of judgment by the step of S 27, the traced vehicle is determined to have caused an accident (S 28).

If a vehicle is determined to have caused an accident in this manner, a dark line type trap 19 is formed on the screen in back and forth of the vehicle 17 having caused an accident (refer to FIG. 2).

As is apparent from the foregoing, the method for detecting an accident detects an accident using the only gray levels for the relevant pixels on the line type trap, thereby more swiftly detecting an accident compared to the method of the box type trap of the related art.

Also, the method for detecting an accident detects an accident using quantity of change and frequency of the gray level, thereby preventing fallacy of mistaking a shadow as a vehicle, possibly accomplishing high reliability in detecting an accident.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for detecting an accident comprising the steps of:
obtaining an image from a predetermined region on a road;
computing gray levels for each pixel corresponding to a predetermined line type trap from the obtained image; and
determining whether there exists an accident or not depending on change transition of the computed gray levels for a predetermined period of time.

2. The method according to claim 1, further comprising the step of displaying the obtained image on a screen.

3. The method according to claim 1, wherein the line type trap is set on a lane.

4. The method according to claim 1, wherein the computed gray levels are average values of gray levels for one pixel or a predetermined number of pixels existing in back and forth of the one pixel.

5. The method according to claim 1, wherein the set line type trap includes pixels arranged in a row.

6. A method for detecting an accident comprising the steps of:
obtaining an image from a predetermined region on a road;
computing gray levels for each pixel corresponding to a predetermined line type trap from the obtained image;
tracking a vehicle using quantity of change for the computed gray levels; and
determining whether there exists an accident or not by tacking the gray levels for the tracked vehicle for a predetermined period of time.

7. The method according to claim 6, further comprising the step of displaying the obtained image on a screen.

8. The method according to claim 6, wherein the line type trap is set on a lane.

9. The method according to claim 6, wherein the computed gray levels are average values of gray levels for one pixel or a predetermined number of pixels existing in back and forth of the one pixel.

10. The method according to claim 6, wherein the set line type trap includes pixels arranged in a row.

11. The method according to claim 6, further comprising the step of determining whether a vehicle is a real vehicle through comparison of gray level information for the traced vehicle included in the line type trap with gray level information for a real vehicle set in advance.

12. The method according to claim 11, wherein if the gray level information is in agreement with gray level information for a real vehicle set in advance, the tracked vehicle is determined to be a real vehicle.

13. The method according to claim 11, wherein the gray level information is quantity of change and frequency for the gray level.

14. The method according to claim 11, if the tracked vehicle is determined to be a real vehicle, a mark is made for a relevant vehicle on a screen corresponding to the determined vehicle.

15. The method according to claim 6, wherein if gray levels for the tracked vehicle do not change for a predetermined period of time, the tracked vehicle is determined to have caused an accident.
